(19) United States
(12) Patent Application Publication
(10) Pub. No.: US 2025/0308727 A1
(43) Pub. Date: Oct. 2, 2025

(54) INSULATED WIRE

(71) Applicant: Proterial, Ltd., Tokyo (JP)

(72) Inventors: Atsuro YAGUCHI, Tokyo (JP); Takanobu WATANABE, Tokyo (JP); Takanori SEKINE, Ibaraki (JP); Yuichi NAKAMURA, Ibaraki (JP); Yoshinori SUZUKI, Ibaraki (JP); Masahiro OKAWA, Ibaraki (JP); Takahiro SUZUKI, Ibaraki (JP); Toshiaki AMANO, Tokyo (JP); Kazufumi SUENAGA, Tokyo (JP)

(21) Appl. No.: 19/079,634

(22) Filed: Mar. 14, 2025

(30) Foreign Application Priority Data
Mar. 26, 2024 (JP) 2024-049038

(51) Int. Cl. H01B 11/18; H01B 3/44

(52) U.S. Cl. CPC H01B 11/1869; H01B 3/445

(57) ABSTRACT

An insulated wire includes a conductor, and a coating layer formed to cover around the conductor as an outermost layer, wherein a thickness of the coating layer is 0.04 mm or less, wherein the coating layer is made of PFA (Polytetrafluoroethylene-perfluoroalkoxyethylene copolymer), and wherein, when an intensity of a polarization-dependent peak is Ip, which is obtained by normalizing an intensity of a peak attributed to C-C stretching vibration of A₁ mode by an intensity of a peak attributed to the C-C stretching vibration of E₂ mode, in Raman spectrum measured by irradiating a laser beam to the coating layer in a polarization direction parallel to a longitudinal direction, and when an intensity of a polarization-dependent peak is Ic, which is obtained by normalizing the intensity of the peak attributed to the C-C stretching vibration of the A₁ mode by the intensity of the peak attributed to the C-C stretching vibration of the E₂ mode, in the Raman spectrum measured by irradiating the laser beam to the coating layer in the polarization direction perpendicular to the longitudinal direction, an orientation degree D expressed in formula (1) is smaller than 0.85,

D=Ip/(Ip+Ic) (1).

### CROSS-REFERENCE TO RELATED APPLICATIONS

The present patent application claims the priority of Japanese patent application No. 2024-049038 filed on Mar. 26, 2024, the entire contents of which are incorporated herein by reference.

### TECHNICAL FIELD

The present invention relates to an insulated wire, i.e., an insulated electric wire.

### BACKGROUND OF THE INVENTION

In recent years, insulated wires have become thinner in order to achieve higher functionality in electronic devices such as VR equipment and wearable devices, as well as more downsized and less invasive medical devices. For example, ultra-thin coaxial cables with an outer diameter of 0.4 mm or less are used as insulated wires for signal transmission. In order to realize such ultra-thin coaxial cables, an extremely thin coating layer is being considered, for example, with the thickness of 40 μm or less.

As prior art literature related to the invention of the present application, Patent Literature 1 is listed.

### CITATION LIST

### Patent Literature

Patent Literature 1: JP2019-192567A

### SUMMARY OF THE INVENTION

Incidentally, the coating layer is formed by extrusion molding. If the temperature during the extrusion molding of the coating layer is raised, the resin foams, so the coating layer tends to tear easily. If the temperature during the extrusion molding is lowered to suppress the resin foaming, the orientation of the resin molecules that make up the coating layer will be aligned, causing the coating layer to tear easily. As a result, the coating layer tends to tear unintentionally during terminal processing and use, and a countermeasure has been desired.

Therefore, an object of the present invention is to provide an insulated wire having a coating layer that is difficult to tear.

For the purpose of solving the above problem, one aspect of the present invention provides an insulated wire includes a conductor, and a coating layer formed to cover around the conductor as an outermost layer, wherein a thickness of the coating layer is 0.04 mm or less, wherein the coating layer is made of PFA (Polytetrafluoroethylene-perfluoroalkoxyethylene copolymer), and wherein, when an intensity of a polarization-dependent peak is Ip, which is obtained by normalizing an intensity of a peak attributed to C-C stretching vibration of A₁ mode by an intensity of a peak attributed to the C-C stretching vibration of E₂ mode, in Raman spectrum measured by irradiating a laser beam to the coating layer in a polarization direction parallel to a longitudinal direction, and when an intensity of a polarization-dependent peak is Ic, which is obtained by normalizing the intensity of the peak attributed to the C-C stretching vibration of the A₁ mode by the intensity of the peak attributed to the C-C stretching vibration of the E₂ mode, in the Raman spectrum measured by irradiating the laser beam to the coating layer in the polarization direction perpendicular to the longitudinal direction, an orientation degree D expressed in formula (1) is smaller than 0.85,

D=Ip/(Ip+Ic) (1).

### Advantageous Effects of the Invention

According to the present invention, it is possible to provide an insulated wire having a coating layer that is difficult to tear.

### BRIEF DESCRIPTION OF DRAWINGS

FIG. 1 is a cross-sectional view of an insulated wire 1 perpendicular to the longitudinal direction in an embodiment of the present invention.

FIG. 2A is an optical microscope image of the surface of a coating layer of sample A.

FIG. 2B and FIG. 2C are mapping images of the sample A formed on the optical microscope image of FIG. 2A.

FIG. 3A is an optical microscope image of the surface of a coating layer of sample B.

FIG. 3B and FIG. 3C are mapping images of the sample B on the optical microscope image of FIG. 3A.

FIG. 4A and FIG. 4B show examples of Raman spectra measured in the mapping measurement in which the mapping image of the sample A shown in FIG. 2B was acquired.

FIG. 5A and FIG. 5B show examples of Raman spectra measured in the mapping measurement in which the mapping image of the sample A shown in FIG. 2C was acquired.

FIG. 6A and FIG. 6B show examples of Raman spectra measured in the mapping measurement in which the mapping image of the sample B shown in FIG. 3B was acquired.

FIG. 7A and FIG. 7B show examples of Raman spectra measured in the mapping measurement in which the mapping image of the sample B shown in FIG. 3C was acquired.

FIG. 8A is a histogram created from the C-C stretching vibration intensity ratio contained in each pixel of the mapping image of the sample A shown in FIG. 2B.

FIG. 8B is a histogram created from the C-C stretching vibration intensity ratio contained in each pixel of the mapping image of the sample A shown in FIG. 2C.

FIG. 9A is a histogram created from the C-C stretching vibration intensity ratio contained in each pixel of the mapping image of the sample B shown in FIG. 3B.

FIG. 9B is a histogram created from the C-C stretching vibration intensity ratio contained in each pixel of the mapping image of the sample B shown in FIG. 3C.

FIG. 10A to FIG. 10E are explanatory diagrams illustrating a cracking test.

### DETAILED DESCRIPTION OF THE INVENTION

### Embodiment

The following is an explanation of an embodiment according to the present invention with reference to the accompanying drawings.

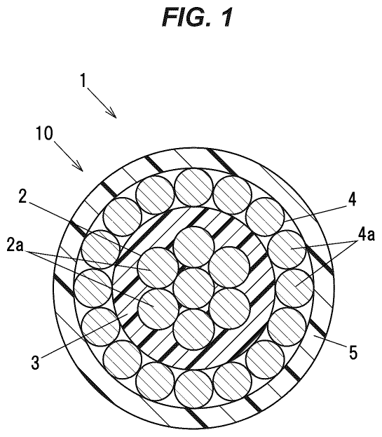

FIG. 1 is a cross-sectional view of an insulated wire (i.e., insulated electric wire) 1 in a direction perpendicular to a longitudinal direction of the insulated wire 1. The insulated wire 1 includes a conductor 2, and a coating layer 5 formed to cover around the conductor 2 as an outermost layer. In the present embodiment, the insulated wire 1 is composed of a coaxial wire 10, which further comprises an insulator 3 covering around the conductor 2, and a shield layer 4 covering around the insulator 3, between the conductor 2 and the coating layer 5. The coaxial wire 10 is used, for example, in endoscopes and in medical equipment for ultrasound diagnostic equipment, or in small electronic equipment, and therefore, it is very thin, with an outer diameter of 0.4 mm or less, and more preferably, 0.2 mm or less.

### (Conductor 2)

The conductor 2 is made of a stranded conductor configured by twisting a plurality of metal strands 2a. The metal strand 2a made of copper or copper alloy can be used, and its surface may be plated. In the present embodiment, seven metal strands 2a, consisting of silver-plated copper alloy wires having an outer diameter of 0.013 mm, were twisted concentrically to form the conductor 2 having an outer diameter of 0.039 mm. A twist pitch of the conductor 2 was 0.7 mm. The twist pitch of conductor 2 is a distance along the longitudinal direction of the insulated wire 1 at which the position of the metal strand 2a is the same in the circumferential direction of the insulated wire 1.

### (Insulator 3)

It is desirable that the insulator 3 be composed of a fluoropolymer that can be molded into thin walls. Here, the insulator 3 made of PFA (Perfluoroalkoxy polymer; Polytetrafluoroethylene-perfluoroalkoxyethylene copolymer) having a thickness of 0.023 mm was used. The insulator 3 was made to have an outer diameter of 0.085 mm.

### (Shield Layer 4)

The shield layer 4 is composed of a laterally wound shield configured by spirally winding a plurality of metal strands 4a around the insulator 3. The metal strand 4a can be made of copper or copper alloy, and its surface may be plated. In the present embodiment, sixteen metal strands 4a made of silver-plated copper alloy wires having an outer diameter of 0.020 mm were used to configure the shield layer 4. It is desirable that the twist direction of the shield layer 4 be the same as the twist direction of the conductor 2. This allows the coaxial wire 10 to be loosened in accordance with bending or twisting when it is bent or twisted, releasing the stress and improving the resistance to bending and twisting. In addition, the twist direction of the conductor 2 and the shield layer 4 is the direction in which the metal strands 2a and 4a are rotated from one end to the other end when viewed from one end of the coaxial wire 10.

### (Coating Layer 5)

The coating layer 5 constitutes the outermost layer of the coaxial wire 10. As the insulator 3, it is desirable that the coating layer 5 be made of a fluoropolymer that can be molded into thin layer. In the present embodiment, the coating layer 5 made of PFA is used. For a thinner coaxial wire 10, it is desirable that the thickness of the coating layer 5 be at least 0.04 mm or less, and more preferably, 0.02 mm or less. The outer diameter of the coating layer 5, i.e., the outer diameter of the coaxial wire 10, is at least 0.4 mm or less, and more preferably, 0.2 mm or less. In the present embodiment, the thickness of the coating layer 5 is 0.02 mm and the outer diameter of the entire coaxial wire 10 is 0.165 mm.

In the present embodiment, since the thickness of the coating layer 5 is formed as thin as 0.04 mm or less (preferably 0.02 mm or less), the coating layer 5 is prone to tearing during terminal processing and the like. However, when the thickness of the coating layer 5 exceeds 0.04 mm, a problem such as easy tearing of the coating layer 5 does not occur in the first place. In other words, the easy tearing of the coating layer 5 is a problem specific to a case where the thickness of the coating layer 5 is reduced to 0.04 mm or less (preferably 0.02 mm or less).

In contrast, in the present embodiment, by adjusting an orientation degree D of the coating layer 5, the easy tearing of the coating layer 5 is suppressed. More specifically, in the present embodiment, the orientation degree D is made smaller than 0.85, and more preferably, the orientation degree D is 0.75 or less. The orientation degree is explained in detail below.

### (Orientation Degree D)

Generally, since the coating layer 5 is formed by extrusion molding, the coating layer 5 tends to be oriented along the longitudinal direction of the insulated wire 1. The inventors of the present invention have found that the higher the orientation degree D of the coating layer 5 in the longitudinal direction of the insulated wire 1, the more likely cracks along the longitudinal direction of the insulated wire 1 are to appear in the coating layer 5.

In the present embodiment, Raman scattering measurement is used to evaluate the orientation degree D of the coating layer 5 (orientation degree of the molecules of resin constituting the coating layer 5). Because the Raman scattering measurement enables the nondestructive evaluation of the orientation degree D of a resin material, problems such as the alteration of the coating layer 5 due to electron beam irradiation when SEM-EDS is used for evaluation do not occur, for example. In the Raman scattering measurement, the spot diameter of the laser irradiated on the surface of the coating layer 5 becomes the measurement area, so the evaluation can be performed within a minute area with a diameter of 1 μm or less. Therefore, it is possible to measure the orientation degree D with high spatial resolution, which is difficult with FT-IR, for example.

In the present embodiment, the coating layer 5 is first irradiated with a polarized laser and a Raman spectrum is measured, and then the orientation degree D of the coating layer 5 is determined based on the relationship between the intensity of the polarization-dependent peak in the measured Raman spectrum, whose intensity depends on the polarization direction of the laser, and the polarization direction. Here, the polarization direction is a direction of polarization on the surface of the coating layer 5 where the laser is irradiated. When the surface of the coating layer 5 is irradiated with a polarized laser, Raman scattering light is generated due to scattering by chemically bonded species coupled in a direction close to the polarization direction, while scattering by chemically bonded species coupled in a direction not close to the polarization direction generates almost no Raman scattering light. Using this phenomenon, the orientation degree D of the coating layer 5 can be evaluated based on the relationship between the intensity of the polarization-dependent peak in the Raman spectrum, whose intensity depends on the polarization direction of the laser, and the polarization direction. It is desirable that the polarization of the laser irradiated to the coating layer 5 be performed using polarization Raman optics with a polarization filter such as a ½ wave plate or polarizer.

More specifically, in the present embodiment, the orientation degree D of the coating layer 5 is evaluated by using the intensity of the polarization-dependent peak measured when the polarization direction is parallel to the longitudinal direction of insulated wire 1 and the intensity of the polarization-dependent peak measured when the polarization direction is perpendicular to the longitudinal direction of insulated wire 1 (parallel to the radial direction of the insulated wire 1). This is because the coating layer 5 is generally most strongly oriented in the direction close to the longitudinal direction of the insulated wire 1, and the difference between the intensity of the polarization-dependent peak measured when the polarization direction is parallel to the longitudinal direction of the insulated wire 1 and that measured when the polarization direction is perpendicular to the longitudinal direction of the insulated wire 1 is large, and these are easy to compare. As the intensity of a peak such as the polarization-dependent peak in the Raman spectrum, peak integral intensity or peak height can be used. The peak integrated intensity can be calculated using the Covell method, for example.

In the present embodiment, the coating layer 5 is made of PFA. In this case, a peak with the maximum peak height (referred to as “peak P₁”) in the range from 1340 cm⁻¹ to 1425 cm⁻¹ (1340 cm⁻¹ or more and 1425 cm⁻¹ or less) in the Raman spectrum that is attributed to the C-C stretching vibration of the A₁ mode can be used as a polarization-dependent peak whose intensity depends on the polarization direction of the laser as described above. Also, the wavenumber at which the height of each peak in the Raman spectrum is maximum can shift depending on the environmental temperature or the like at the time of measurement. However, large and small relationships of the wavenumber at which the height of these peaks is maximum remain the same, so the peaks cannot be incorrectly identified. When the orientation degree D of the sheath layer 5 is high in the longitudinal direction of the insulated wire 1, the difference in the intensity of peak P₁ is large between a case where the polarization direction is close (close to parallel) to the longitudinal direction of the insulated wire 1 and a case where it is not close to it (close to vertical). Conversely, when the orientation degree D of the coating layer 5 in the longitudinal direction of the insulated wire 1 is low, the difference in the intensity of peak P₁ is small between a case where the polarization direction is close to the longitudinal direction of the insulated wire 1 and a case where it is not close to it. Therefore, the orientation degree D of the coating layer 5 can be evaluated by comparing the intensity of peak P₁ when the polarization direction is close to the longitudinal direction of the insulated wire 1 and when it is not close to it.

Additionally, in the present embodiment, in order to evaluate the orientation degree D of the coating layer 5 made of PFA more precisely, the intensity of the polarization-dependent peak was normalized by the intensity of a peak with the maximum peak height (referred to as “peak P₂”) in the range from 1255 cm⁻¹ to 1340 cm⁻¹ (1255 cm⁻¹ or more and 1340 cm⁻¹ or less) in the Raman spectrum that is attributed to the C-C stretching vibration of the E₂ mode. The intensity of the peak attributed to the C-C stretching vibration of the E₂ mode is almost independent of the laser polarization direction. If the intensity of peak P₁ is I₁ and the intensity of peak P₂ is I₂, then the ratio of the intensities of peak P₁ and peak P₂, I₁/I₂ (hereafter referred to as “C-C stretching vibration intensity ratio”), is the intensity of peak P₁ normalized by the intensity of peak P₂.

In the following description, in the Raman spectrum measured by irradiating a laser beam to the coating layer 5 in the polarization direction parallel to the longitudinal direction of the insulated wire 1, the intensity of polarization-dependent peak (C-C stretching vibration intensity ratio) is Ip, which is the intensity I₁ of peak P₁ attributed to the C-C stretching vibration of the A₁ mode normalized by the intensity I₂ of peak P₂ attributed to the C-C stretching vibration of the E₂ mode. Also, in the Raman spectrum measured by irradiating a laser beam onto the coating layer 5 in the polarization direction perpendicular to the longitudinal direction of the insulated wire 1, the intensity of the polarization-dependent peak (C-C stretching vibration intensity ratio) is Ic, which is the intensity I₁ of peak P₁ attributed to the C-C stretching vibration of the A₁ mode normalized by the intensity I₂ of peak P₂ attributed to the C-C stretching vibration of the E₂ mode. In the present embodiment, the orientation degree D is defined by the following formula (1):

D=Ip/(Ip+Ic) (1).

For the intensities Ip and Ic of the polarization-dependent peaks, it is preferable to take an average of multiple polarization-dependent peaks of the intensities Ip and Ic by performing measurements at multiple positions, taking into account the variation of the intensity at each measurement position. In this case, for example, a method of mapping measurement of Raman spectra can be used. The mapping measurement is a measurement method in which the measurement is repeated while scanning the measurement points (laser irradiation points) within a predetermined measurement area on the surface of an object to be measured. For example, perform a mapping measurement on the Raman spectrum, and create a histogram of the intensities Ip and Ic of the polarization-dependent peaks in each pixel of the obtained mapping image. Then an average can be obtained from the created histogram.

### (Specific Example of how to Obtain the Orientation Degree D)

The following is a more specific explanation of how to determine the orientation degree D using the measurement results of sample A, which is prone to cracking along the longitudinal direction of the insulated wire 1, and sample B, which is less prone to cracking along the longitudinal direction of the insulated wire 1.

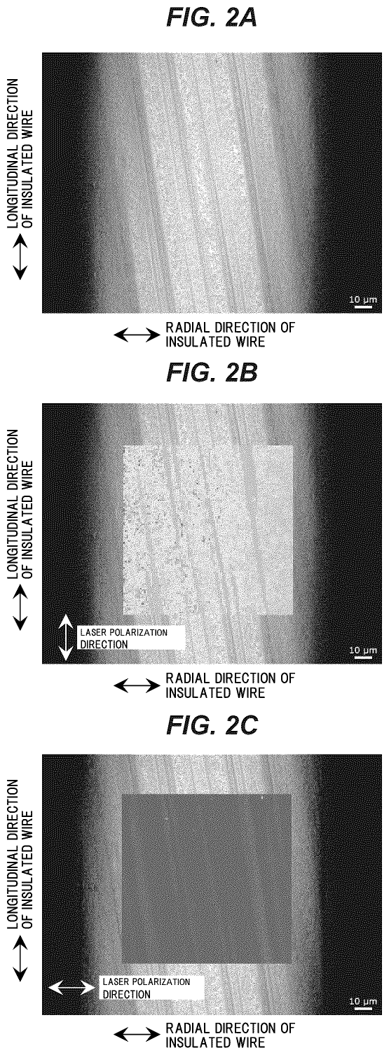

FIG. 2A is an optical microscope image of the surface of the coating layer 5 of sample A, which is prone to cracking along the longitudinal direction of the insulated wire 1. FIGS. 2B and 2C are mapping images of the Raman spectra of the sample A formed on the optical microscope image of FIG. 2A. The mapping image in FIG. 2B was obtained by mapping measurement performed with the laser polarization direction parallel to the longitudinal direction of the insulated wire 1, and the mapping image in FIG. 2C was obtained by mapping measurement performed with the laser polarization direction perpendicular to the longitudinal direction of the insulated wire 1 (parallel to the circumferential direction).

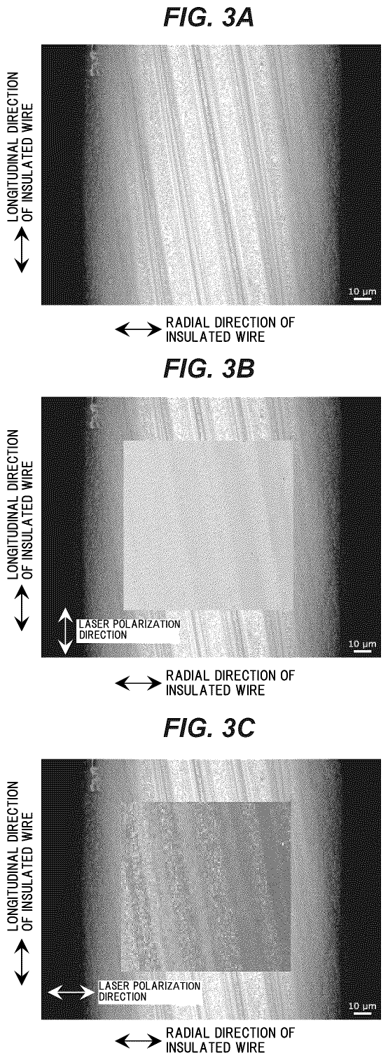

FIG. 3A is an optical microscope image of the surface of the coating layer 5 of sample B, where cracks along the longitudinal direction of the insulated wire 1 are less likely to occur. FIGS. 3B and 3C are mapping images of the Raman spectra of the sample B formed on the optical microscope image of FIG. 3A. The mapping image of FIG. 3B was obtained from a mapping measurement performed with the laser polarization direction parallel to the longitudinal direction of the insulated wire 1, and the mapping image in FIG. 3C was obtained from a mapping measurement performed with the laser polarization direction perpendicular to the longitudinal direction of the insulated wire 1.

Each pixel in the mapping images in FIGS. 2B, 2C, 3B, and 3C includes the C-C stretching vibration intensity ratio data obtained from the Raman spectra measured at its location, and each pixel has a color corresponding to the magnitude of the C-C stretching vibration intensity ratio (i.e., the intensities of the polarization-dependent peak Ip, Ic). In calculating the C-C stretching vibration intensity ratio of each pixel in these mapping images, peak areas of peak P₁ and peak P₂, calculated using the Covell method, were used as the intensities of peak P₁ and peak P₂. In this calculation of peak areas by the Covell method, the range of wavenumbers over which a peak area was measured was defined as a ±21 cm⁻¹ range centered on a wavenumber where the height of peak was the maximum. Comparing the mapping images in FIGS. 2B, 2C, 3B, and 3C, the difference in the C-C stretching vibration intensity ratio of the mapping images of sample A between FIG. 2B and FIG. 2C is larger than that of the mapping images of the sample B between FIG. 3B and FIG. 3C. This result indicates that the orientation degree D of the coating layer 5 in the longitudinal direction of the insulated wire 1 is higher for the sample A, in which the coating layer 5 is prone to cracking along the longitudinal direction of the insulated wire 1, than for sample B, in which the coating layer 5 is less prone to cracking along the longitudinal direction of the insulated wire 1.

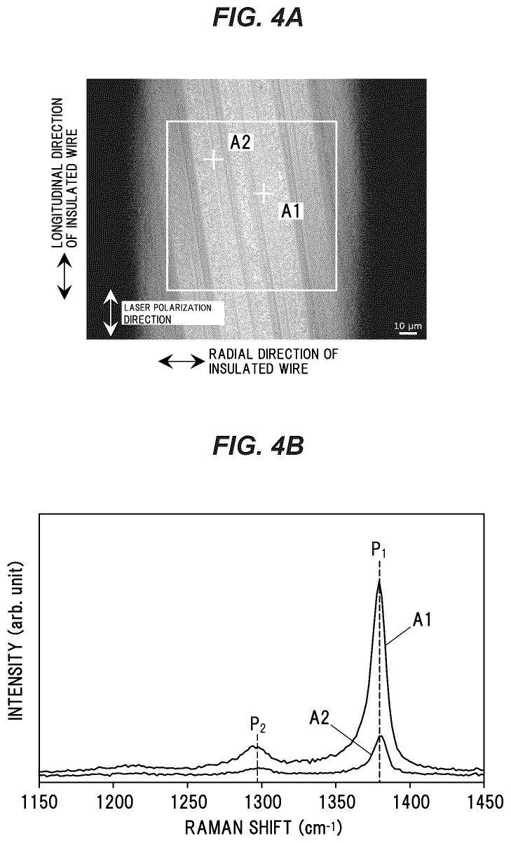

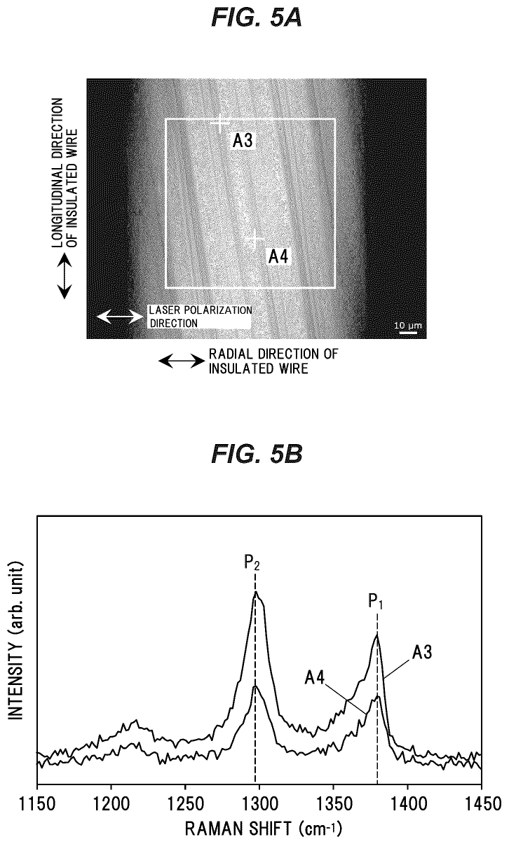

FIGS. 4A and 4B show examples of Raman spectra measured in the mapping measurement in which the mapping image of sample A shown in FIG. 2B was acquired. The Raman spectra shown in FIG. 4B were measured at the measurement positions A₁ and A₂ indicated by the cross marks in FIG. 4A. FIGS. 5A and 5B also show examples of Raman spectra measured in the mapping measurement in which the mapping image of sample A shown in FIG. 2C was acquired. The Raman spectra shown in FIG. 5B were measured at the measurement positions A₃ and A₄ indicated by the cross marks in FIG. 5A.

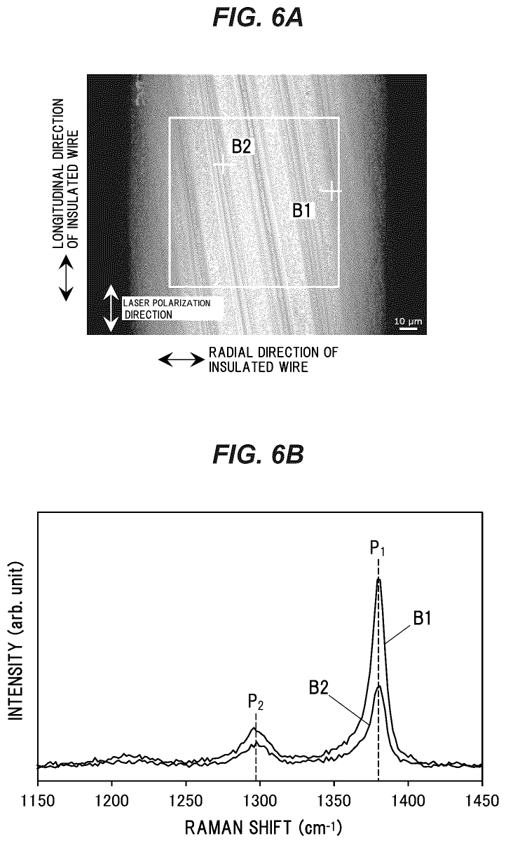

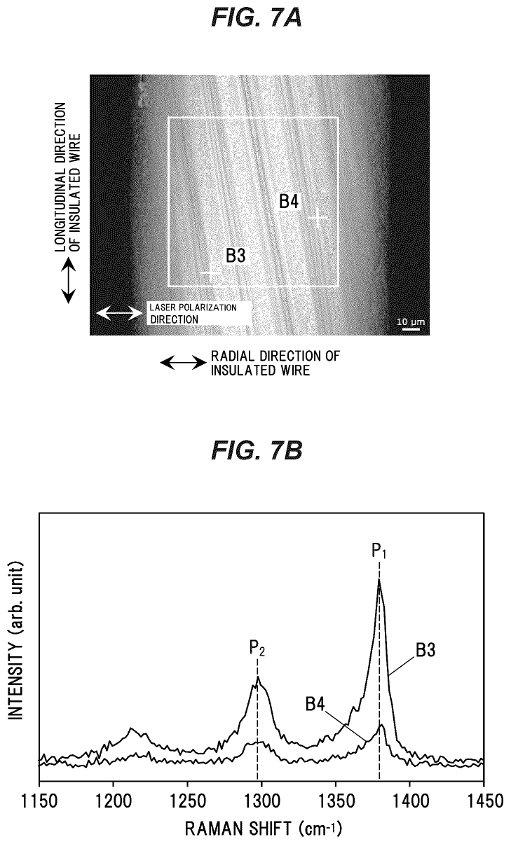

FIGS. 6A and 6B show examples of Raman spectra measured in the mapping measurement in which the mapping image of sample B shown in FIG. 3B was acquired. The Raman spectra shown in FIG. 6B were measured at the measurement positions B1 and B2 indicated by the cross marks in FIG. 6A. FIGS. 7A and 7B also show examples of Raman spectra measured in the mapping measurement in which the mapping image of sample B shown in FIG. 3C was acquired. The Raman spectra shown in FIG. 7B were measured at the measurement positions B3 and B4 indicated by the cross marks in FIG. 7A. The position of peak P₁, which is a polarization-dependent peak, and the position of peak P₂, which is used to normalize the intensity I₁ of peak P₁, are indicated by dashed lines in FIGS. 4B, 5B, 6B, and 7B. Based on the intensity I₁ of peak P₁ and the intensity I₂ of peak P₂, the C-C stretching vibration intensity ratio I₁/I₂ (i.e., intensities Ip and Ic of the polarization-dependent peaks) can be obtained.

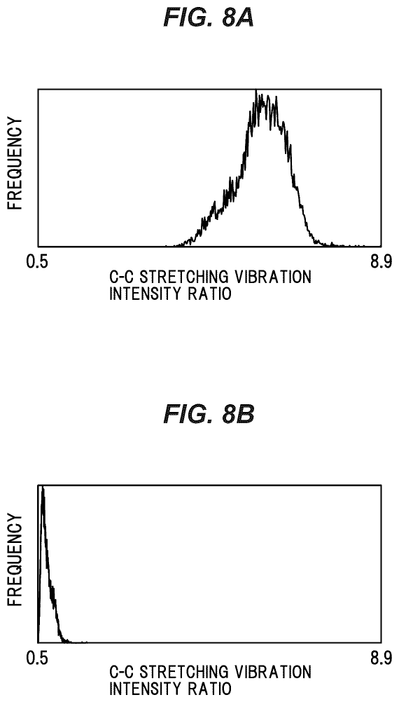

FIG. 8A is a histogram created from the C-C stretching vibration intensity ratio I₁/I₂ (i.e., intensity of polarization-dependent peak Ip) contained in each pixel of the mapping image of sample A shown in FIG. 2B, which was measured with the polarization direction of the laser in parallel to the longitudinal direction of insulated wire 1. FIG. 8B is a histogram created from the C-C stretching vibration intensity ratio I₁/I₂ (i.e., intensity of polarization-dependent peak Ic) contained in each pixel of the mapping image of sample A shown in FIG. 2C, which was measured with the polarization direction of the laser in in perpendicular to the longitudinal direction of insulated wire 1.

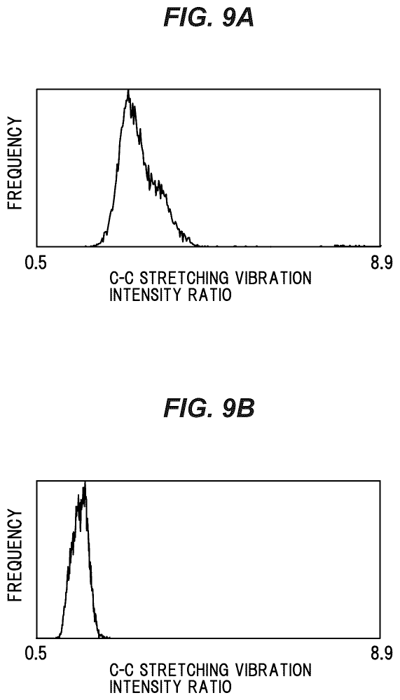

FIG. 9A is a histogram created from the C-C stretching vibration intensity ratio I₁/I₂ (i.e., intensity of polarization-dependent peak Ip) contained in each pixel of the mapping image of the sample B shown in FIG. 3B, which was measured with the polarization direction of the laser in parallel to the longitudinal direction of insulated wire 1. FIG. 9B is a histogram created from the C-C stretching vibration intensity ratio I₁/I₂ (i.e., intensity of polarization-dependent peak Ic) contained in each pixel of the mapping image of sample B shown in FIG. 3C, which was measured with the polarization direction of the laser perpendicular to the longitudinal direction of insulated wire 1. In addition, in the histograms shown in FIGS. 8A, 8B and FIGS. 9A, 9B, the horizontal axis represents the C-C stretching vibration intensity ratio I₁/I₂ divided into 256 classes in the range from the minimum to the maximum, and the vertical axis represents the frequency which is a number of pixels in each class.

With the histograms in FIGS. 8A, 8B and FIGS. 9A, 9B, the average values of the intensities Ip and Ic of the polarization-dependent peaks can be obtained by the following formula:

{Sum of (Class value×Frequency)}÷{Sum of frequency}.

Then, using the obtained average values, the orientation degree D can be obtained by the above formula (1).

### (Relation Between the Orientation Degree D of the Coating Layer 5 and its Resistance to Tearing)

### Example 1

As Example 1, using a 15-mm extruder with a full-flight screw with an L/D ratio of 20, a plurality of coaxial wires 10 shown in FIG. 1 were made by extruding a coating layer 5 consisting of PFA with a thickness of 0.02 mm (335° C., melt viscosity 1.5×103 Pa/s at a shear rate of 121.6 (1/s)) under the following conditions: cylinder temperature C1 (upstream)/C2 (center)/C3 (downstream)=265° C./325° C./330° C., nozzle temperature 330° C., crosshead temperature 335° C., die temperature 335° C., mouth diameter 4.0 mm, core diameter 2.5 mm, extrusion temperature 335° C., and screw rotation speed 0.6 rpm. The orientation degree D was measured for the coating layer 5 of the obtained coaxial wires 10 and was 0.75.

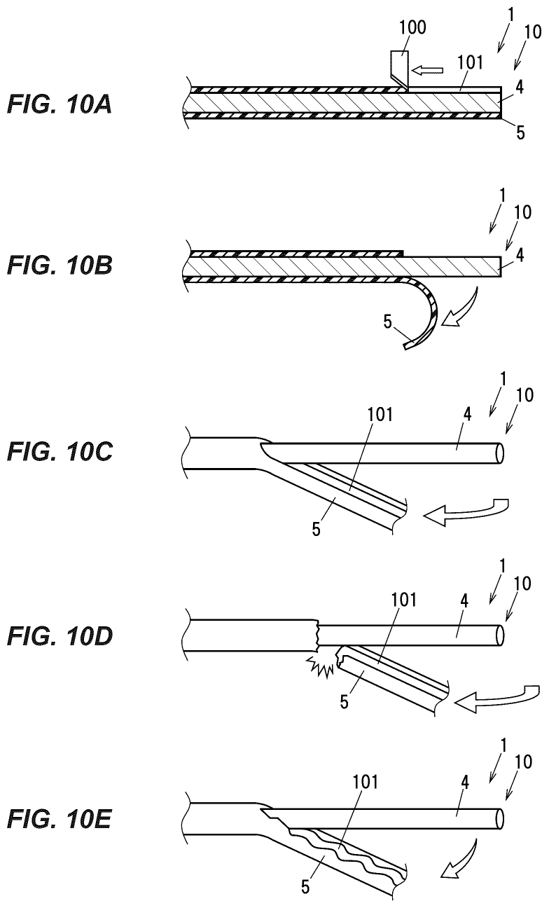

In addition, a cracking test was performed on the obtained coating layer 5. In the cracking test, as shown in FIG. 10A, a cut (i.e., break) 101 of 20 mm to 30 mm was made at the tip of the coaxial wire 10 along the longitudinal direction of the coating layer 5, using a razor blade 100, and then the coating layer 5 was peeled off by pulling toward the base end as shown in FIG. 10B. As a result, if the cut 101 easily developed in the longitudinal direction of the coaxial wire 10 as shown in FIG. 10C, the coating layer 5 was considered to be easily torn and was rejected. In addition, when the sheath layer 5 was broken without developing of the cut 101 as shown in FIG. 10D, or when the sheath layer 5 was plastically deformed (necking) under load while tearing developed from the cut 101 as shown in FIG. 10E, the sheath layer 5 was considered to be difficult to tear and passed the examination. When the cracking tests were conducted on multiple coaxial wires 10 of Example 1, none of them were rejected, so the passing rate was 100%.

### Example 2

As Example 2, multiple coaxial wires 10 were made by extruding the coating layer 5 using the same 15-mm extruder as in Example 1, under the same conditions except that the crosshead temperature and die temperature were set to 340° C. and the screw rotation speed was set to 0.8 rpm. The orientation degree D was measured for the coating layer 5 of the obtained coaxial wires 10 of Example 2, and was 0.62. Also, the cracking test was performed on the coaxial wires 10 of Example 2, and the passing rate was 100%.

### Example 3

As Example 3, multiple coaxial wires 10 were made by extruding the coating layer 5 using the same 15-mm extruder as in Examples 1 and 2 under the same conditions except that the crosshead temperature and die temperature were set to 345° C. and the screw rotation speed was set to 1.1 rpm. The orientation degree D was measured for the coating layer 5 of the obtained coaxial wires 10 of Example 3, and was 0.68. Also, the cracking test was performed on the coaxial wires 10 of Example 3, and the passing rate was 100%.

In contrast, several coaxial wires were made as comparative examples by extruding the coating layer 5 using the same 15-mm extruder as in Examples 1 to 3, under the same conditions except that the crosshead temperature and die temperature were set to 335° C. and the screw speed was set to 0.8 rpm. The coaxial wires in the comparative examples were the same as the coaxial wires 10 in Examples except that the conditions for extrusion molding of the coating layer 5 were changed. The orientation degree D was measured for the coating layer 5 of the obtained coaxial wires in the comparative examples and was 0.85. When cracking tests were conducted on several coaxial wires 10 in the comparative examples in the same manner as in Examples, they all failed, resulting in a passing rate of 0%.

From the above results, it was found that when forming the coating layer 5 by thin-wall molding of PFA, the orientation degree D must be at least smaller than 0.85 to make the coating layer 5 tear-resistant and that a tear-resistant coating layer 5 can be obtained more reliably by setting the orientation degree D to 0.75 or less. It was also confirmed that the orientation degree D of the coating layer 5 can be adjusted by adjusting the conditions of extrusion molding of the coating layer 5 (extrusion temperature, screw rotation speed) as appropriate.

### Advantageous Effects of the Embodiments

As explained above, in the insulated wire 1 according to the present embodiment, the coating layer 5 is made of PFA with a thickness of 0.04 mm or less, and the orientation degree D expressed in the above formula (1) is smaller than 0.85. This makes it possible to realize an insulated wire 1 having the coating layer 5 difficult to tear.

### Summary of the Embodiments

Next, technical ideas understood from the above embodiments, will be described with reference to the reference numerals and the like used in the embodiments. However, each reference numeral in the following description does not limit the constituent elements in the scope of claims to the members and the like specifically shown in the embodiments.

According to the first feature, an insulated wire 1 comprises a conductor 2; and a coating layer 5 formed to cover around the conductor 2 as an outermost layer, wherein a thickness of the coating layer 5 is 0.04 mm or less, wherein the coating layer 5 is made of PFA (Polytetrafluoroethylene-perfluoroalkoxyethylene copolymer), and wherein, when an intensity of a polarization-dependent peak is Ip, which is obtained by normalizing an intensity of a peak attributed to C-C stretching vibration of A₁ mode by an intensity of a peak attributed to the C-C stretching vibration of E₂ mode, in Raman spectrum measured by irradiating a laser beam to the coating layer 5 in a polarization direction parallel to a longitudinal direction, and when an intensity of a polarization-dependent peak is Ic, which is obtained by normalizing the intensity of the peak attributed to the C-C stretching vibration of the A₁ mode by the intensity of the peak attributed to the C-C stretching vibration of the E₂ mode, in the Raman spectrum measured by irradiating the laser beam to the coating layer 5 in the polarization direction perpendicular to the longitudinal direction, an orientation degree D expressed in formula (1) is smaller than 0.85,

D=Ip/(Ip+Ic) (1).

According to the second feature, in the insulated wire 1 as described by the first feature, the orientation degree D is 0.75 or less.

According to the third feature, in the insulated wire 1 as described by the first feature, the thickness of the coating layer 5 is 0.02 mm or less.

According to the fourth feature, the insulated wire 1 as described by the first feature, further includes an insulator 3 covering around the conductor 2, and a shield layer 4 covering around the insulator 3, between the conductor 2 and the coating layer 5, wherein an outer diameter of the coating layer 5 is 0.4 mm or less.

According to the fifth feature, in the insulated wire 1 as described by the fourth feature, the outer diameter of the coating layer 5 is 0.2 mm or less.

### (Note)

That is all for the description of the embodiment of the present invention. The embodiment does not limit the invention according to the scope of claims. Also, it should be noted that not all combinations of features are essential to the means for solving problems of the invention. In addition, the invention can be implemented with various modifications without departing from the scope and spirit of the invention.

1. An insulated wire, comprising:
a conductor; and
a coating layer formed to cover around the conductor as an outermost layer,
wherein a thickness of the coating layer is 0.04 mm or less,
wherein the coating layer is made of PFA (Polytetrafluoroethylene-perfluoroalkoxyethylene copolymer), and
wherein, when an intensity of a polarization-dependent peak is Ip, which is obtained by normalizing an intensity of a peak attributed to C-C stretching vibration of A₁ mode by an intensity of a peak attributed to the C-C stretching vibration of E₂ mode, in Raman spectrum measured by irradiating a laser beam to the coating layer in a polarization direction parallel to a longitudinal direction, and when an intensity of a polarization-dependent peak is Ic, which is obtained by normalizing the intensity of the peak attributed to the C-C stretching vibration of the A₁ mode by the intensity of the peak attributed to the C-C stretching vibration of the E₂ mode, in the Raman spectrum measured by irradiating the laser beam to the coating layer in the polarization direction perpendicular to the longitudinal direction, an orientation degree D expressed in formula (1) is smaller than 0.85,
D=Ip/(Ip+Ic) (1).

2. The insulated wire, according to claim 1, wherein the orientation degree D is 0.75 or less.

3. The insulated wire, according to claim 1, wherein the thickness of the coating layer is 0.02 mm or less.

4. The insulated wire, according to claim 1, further comprising:
an insulator covering around the conductor, and a shield layer covering around the insulator, between the conductor and the coating layer,
wherein an outer diameter of the coating layer is 0.4 mm or less.

5. The insulated wire, according to claim 1, wherein the outer diameter of the coating layer is 0.2 mm or less.
